(19) United States
(12) Patent Application Publication
(10) Pub. No.: US 2005/0262281 A1
(43) Pub. Date: Nov. 24, 2005

(54) Managing a shared resource

(76) Inventors: Prakash H. Nayak, Bangalore (IN); Sachin Doshi, Bangalore (IN)

Correspondence Address: FISH & RICHARDSON, PC, 12390 EL CAMINO REAL, SAN DIEGO, CA, 92130-2081, US

(21) Appl. No.: 10/852,770

(22) Filed: May 21, 2004

(51) Int. Cl. G06F 13/36

(52) U.S. Cl. 710/244

(57) ABSTRACT

A method for managing a shared resource includes pseudorandomly selecting a first port from a plurality of ports that accept requests to access a shared resource, and granting access to the shared resource for current requests from the plurality of ports, with granting of access in a deterministic order starting from a currently requesting port that is deterministically related to the first port.

### BACKGROUND

Systems for transmitting and/or processing data often include shared resources such as memory, a data bus, or a data pipeline. The shared resource is shared among various physical or logical “requesters” that request access to the shared resource. Such systems may use an arbitration scheme to select a requester to access the shared resource. Arbitration schemes include round-robin arbitration, batch arbitration, and random arbitration.

### DESCRIPTION OF DRAWINGS

FIG. 1 is a block diagram depicting a system for transferring data among computer systems.

FIG. 2 is a block diagram of an arbitration system used in a network device.

FIG. 3 is a block diagram of an arbitration module.

FIG. 4 is a flowchart for an arbitration process.

### DESCRIPTION

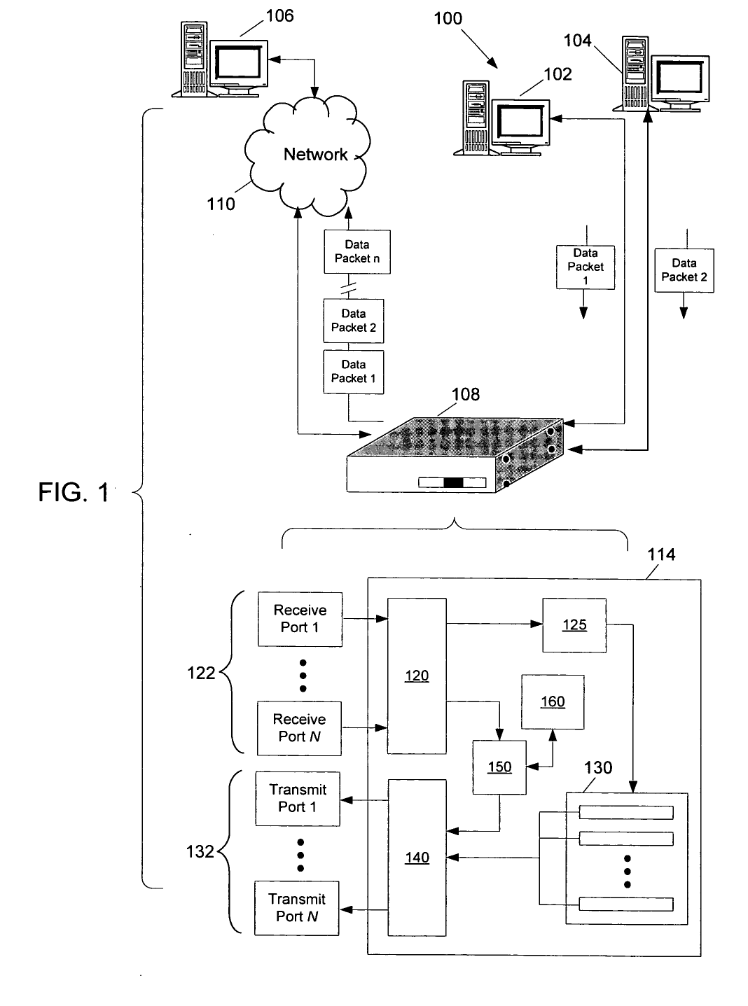

Referring to FIG. 1, a system 100 for transmitting data among computer systems includes a network device 108 (e.g., a router or switch) for directing data packets. Some computer systems (e.g., computer systems 102 and 104) are in communication with the network device 108 over a dedicated link. Other computer systems (e.g., computer systems 106) are in communication with the network device 108 via a network 110 (e.g., a local area network or a wide area network). The network device 108 includes a network processing engine 114 that collects data packets received over a set of receive ports 122 and directs the data over one of set of transmit ports 132 for delivery to the appropriate destination computer system. In this example, “data packet_{—}1” is transmitted from the computer system 102 for delivery to computer system 106 and “data packet_{—}2” is transmitted from computer system 104 for delivery to computer system 106.

The network device 108 includes receive ports 122 and transmit ports 132 that are paired together (e.g., on a line card) for communicating over a full-duplex link to a single “link partner” (e.g., computer system 102 or 104, or a node of the network 110). Alternatively, the network device 108 may include a bidirectional port (i.e., a port that acts both as a transmit port and a receive port) for communicating over a “half-duplex” shared access medium to a device in communication with the shared access medium (e.g., computer system 106 or a node of the network 110).

Individual line cards may include one or more physical layer (PHY) devices (e.g., optic, wire, and wireless PHYs) that handle communication over network connections. The PHY devices translate between the physical signals carried by different network mediums and the bits (e.g., “0”-s and “1”-s) used by digital systems. The line cards may also include framer devices (e.g., Ethernet, Synchronous Optic Network (SONET), High-Level Data Link (HDLC) framers or other “layer 2” devices) that can perform operations on frames such as error detection and/or correction.

The network processing engine 114 includes an aggregation module 120 that collects data packets received from the receive ports 122. When a packet is received, the header portion of the packet is sent to the control module 125 for processing, and a packet memory manager 150 temporarily stores the data payload portion of the packet in a packet buffer 160. The header portion of a collected data packet flows through a shared pipeline within a control module 125 before being switched to a transmit queue in a transmit queue manager 130 that is associated with one of the transmit ports 132. A distribution module 140 distributes packets with the appropriate headers from the transmit queues and data payload from the packet buffer 160 to the appropriate transmit port.

The aggregation module 120 uses an arbitration system to select a packet from a particular receive port to be sent to the shared pipeline next. A packet received at a receive port is processed by the aggregation module 120 as a request to access the shared pipeline.

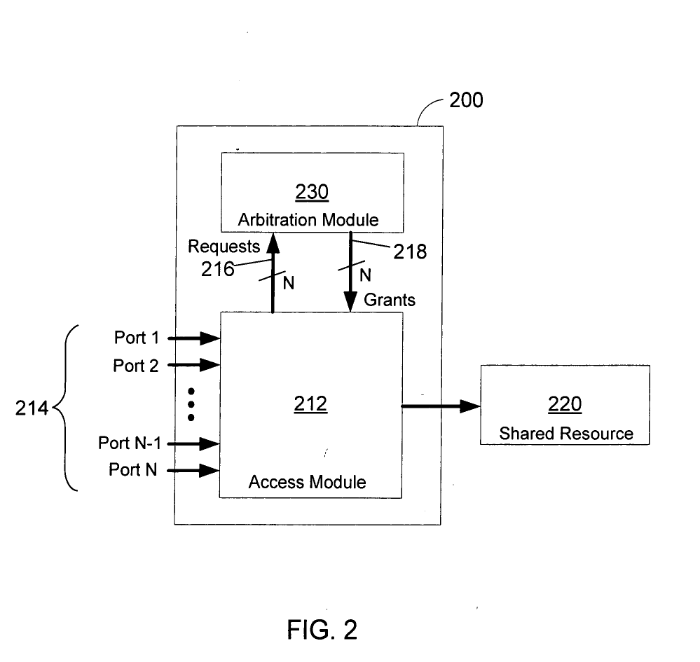

Referring to FIG. 2, one example of an arbitration system 200 that can be used by the aggregation module 120 includes an access module 212 that has a set of N ports 214 (logically addressed from Port 1 to Port N) that receive requests to access a shared resource 220. The ports 214 can represent physical ports used to receive data or logical access points used by devices to request for access, and to access, the shared resource 220. The arbitration system 200 also includes an arbitration module 230 that takes N requests 216 (e.g., binary logic lines or Boolean variables) as input, and based on those requests 216 generates a series of grants 218 to determine which port is granted access to the shared resource 220 (i.e., a “granted port”). In the case of the network device 108, a packet received at a “granted port” of the input ports 122 is sent to the shared pipeline within control module 125.

The arbitration system 200 can use hardware (e.g., circuitry), software (e.g., variables), or a combination of hardware and software. For example, the requests 216 and/or grants 218 can be communicated using binary logic lines, or Boolean variables.

The arbitration system 200 grants access to the shared resource 220. The arbitration system 200 starts an arbitration cycle by pseudorandomly selecting (e.g., using a pseudorandom number generator (PRNG)) a “reference port” from the input ports 214. The selected reference port may or may not be currently requesting access to the shared resource (e.g., a port 122 may or may not have a received packet for the pipeline 130).

During the arbitration cycle, the arbitration system 200 grants access to the shared resource 220 for ports that have “valid” requests. A request is valid, if the port is currently requesting access and has not yet been granted access to the shared resource 220 during the current arbitration cycle. The order in which valid requests are granted during an arbitration cycle is a deterministic order starting from a currently requesting port that is deterministically related to the selected reference port, as described below in more detail.

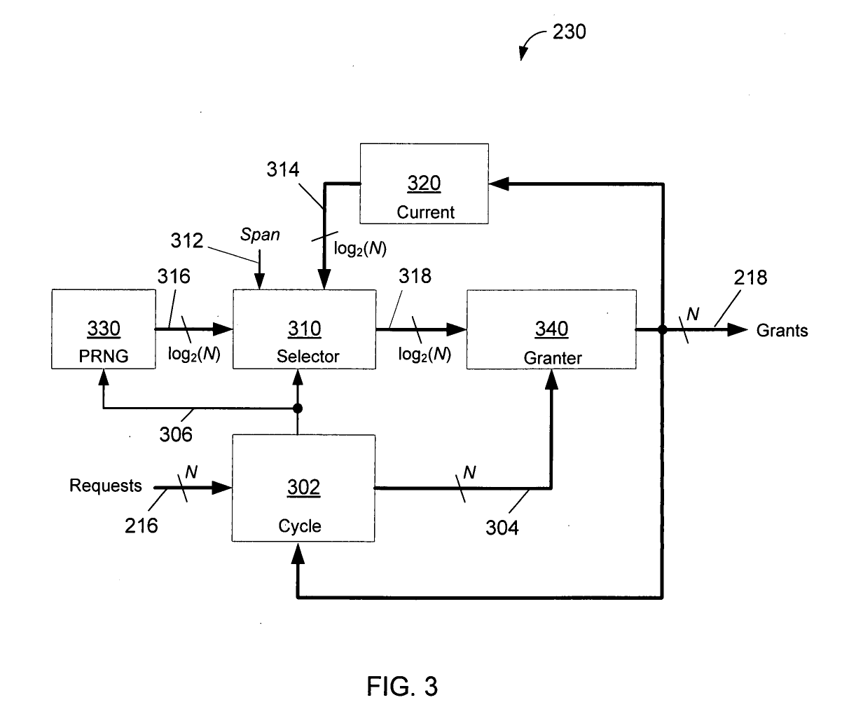

Referring to FIG. 3, a logical block diagram of an exemplary arbitration module 230 includes a cycle module 302 that determines when a new arbitration cycle begins. The cycle module 302 takes the requests 216 as input. The values of the requests 216 are represented by Request(n) for n=1 to N, where Request(n)=1 if Port n is currently requesting access to the shared resource 220 and Request(n)=0 if Port n is not currently requesting access to the shared resource. The cycle module 302 also takes the grants 218 as input. The values of the grants 218 are represented by Grant(n) for n=1 to N, where Grant(n)=1 if Port n is granted access to the shared resource 220, and Grant(n)=0 otherwise. Grant(n) is only TRUE (i.e., equal to “1” in this example using positive logic) for one value of n in the range 1 to N at a time.

The cycle module 302 generates a ValidRequest(n) output 304 (for n=1 to N) and a CycleDone output 306. The cycle module 302 determines the logical values of these outputs by:
ValidRequest(n)=Request(n) AND (n not yet granted this cycle), and
CycleDone=(for all n, ValidRequest(n)=0).
The CycleDone value 306 is TRUE at the transition from one arbitration cycle to the next arbitration cycle, after all current requests have been granted at least once during the current arbitration cycle. After the CycleDone value 306 becomes TRUE and triggers a new arbitration cycle, the CycleDone value is cleared (i.e., set to FALSE) until there is at least one valid request.

A selector module 310 determines the value of a port index C that is used in selecting a first port to be granted access in an arbitration cycle. The selector module 310 subsequently increments the port index C to grant other ports access in that arbitration cycle. The selector module 310 takes as inputs the CycleDone value 306, a Span value 312, a Current value 314 (encoded by the current module 320 as a log₂(N)-bit binary representation of the currently granted port), and a random number R. The random number R is a random number from 1 to N generated by a PRNG 330 and sent to selector module 310 in the form of a log₂(N)-bit binary number 316. The PRNG 330 generates a new random number each for each new arbitration cycle as determined by the CycleDone value 306. The value Span is set (e.g., pre-programmed or input by a user) to a value between 0 and 1 (e.g., 0.25, 0.5, 0.75, or 1) according to desired characteristics of the arbitration module 230, as described in more detail below.

The selector module 310 calculates the port index value C that starts (at the beginning of an arbitration cycle) at the value of a pseudorandomly selected “reference port” given by:
C=(Current−┌Span·R┐)mod N.
A granter module 340 performs a “grant” for a Port m by setting Grant(m)=1 (and Grant(k)=0 for k≠m). During an arbitration cycle, the selector module 310 increases the port index value C between grants based on the value of Current according to C=(Current+1)mod N. The value of C is sent to the granter module 340 in the form of a log₂(N)-bit binary number 318.

The granter module 340 selects the next port to be granted access by selecting a Port m with ValidRequest(m)=1 (i.e., TRUE) and with the lowest value of ((m−C) mod N). This selection rule used to determine the order of grants in an arbitration cycle corresponds to a round-robin arbitration scheme. Other deterministic orderings are possible. For example, an ordering corresponding to a batch arbitration scheme includes latching a set of all requesting ports at the beginning of an arbitration cycle and granting those ports during the arbitration cycle, using a deterministic selection rule to select a first granted port related to the pseudorandomly selected reference port.

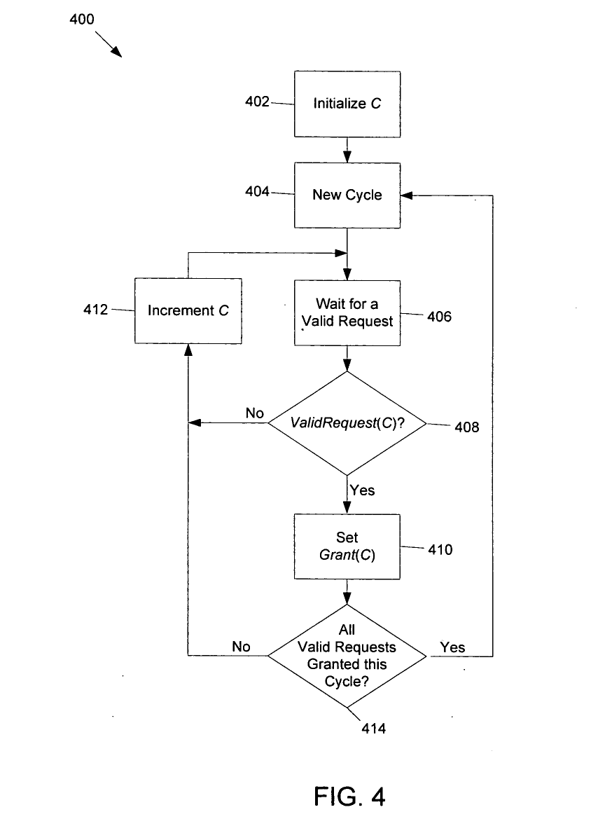

Referring to FIG. 4, an arbitration process 400 that is executed by the arbitration module 230 includes initializing 402 all grants 218 to Grant(n)=0 (for all n) and Current=0. The process 400 starts a new arbitration cycle 404 by setting C=(Current−┌Span·R┐)mod N. If no port has a valid request (e.g., because no port is currently requesting access to the shared resource), then the process 400 waits 406 for at least one valid request.

The process 400 tests 408 whether the current port index C corresponds to a valid request by testing the value of ValidRequest(C), and if so, performs a new grant 410 for Port C. In performing a grant for Port C, the process 400 sets the value of Grant(C)=1 and waits for Port C to finish using the resource (e.g., to finish transferring a received packet into the pipeline). If the current port index does not correspond to a valid request, then the process increments 412 the port index to C→(C+1)mod N and tests 408 the next port index.

After the process 400 performs a new grant 410, the process 400 determines 414 whether all currently valid requests have been granted at least once during the current arbitration cycle, and if so, starts a new arbitration cycle 404. Otherwise, the process 400 increments 412 the port index to grant the next valid request.

The arbitration process 400 grants access to the shared resource 220 fairly while limiting the worst-case latency between two successive grants for a continuously requesting port. Since the port that is granted access first is determined randomly, the likelihood of a port being blocked from gaining fair access (e.g., a periodically requesting port missing a potential grant window in a purely deterministic arbitration scheme) is reduced.

The characteristics of the arbitration module 230 can be controlled by the Span value. The worst-case latency between two successive grants for a continuously requesting port could be as large as 2N-1 for a value of Span=1. For example, for N=4 with all four ports continuously requesting the resource, one arbitration cycle may grant in the order 2, 3, 4, 1. The next arbitration cycle may grant in the order 3, 4, 1, 2. In this worst-case example, the number of grants from one grant for Port 2 to the next successive grant for Port 2 is 7 grants.

If the network device 108 accepts packets at each port at a given acceptance rate, the worst-case latency can affect the amount of buffer space needed to store the received packets before they are transferred to the pipeline 130, and/or the maximum value of the packet acceptance rate. For example, the buffer space used by the network device 108 may be as large as the product of the number of ports, the size of a packet, the packet acceptance rate, the maximum grant time, and the worst-case latency between grants.

A smaller value of Span lowers the worst-case latency from 2N-1 (for Span=1) to N (for Span=0). However, a smaller value of Span may also decrease the fairness that is associated with an arbitration cycle being able to start by granting the resource to any of the ports. Accordingly, if the reference port is selected from a subset of the ports (determined by Span), the randomness and/or fairness may be reduced for a better worst-case latency. A value of Span that is small enough such that ┌Span·N┐=0 results in each arbitration cycle starting with the same reference port.

The term packet was sometimes used in the above description to refer to a frame. However, the term packet also refers to a TCP segment, fragment, Asynchronous Transfer Mode (ATM) cell, and so forth, depending on the network technology being used.

The processes and modules described herein can be implemented in digital electronic circuitry, or in computer hardware, firmware, software, or in combinations of them. The processes described herein can be implemented as a computer program product, i.e., a computer program tangibly embodied in an information carrier, e.g., in a machine-readable storage device or in a propagated signal, for execution by, or to control the operation of, data processing apparatus, e.g., a processing device, a computer, or multiple computers. A computer program can be written in any form of programming language, including compiled, assembled, or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Particular embodiments have been described, however other embodiments are within the scope of the following claims. For example, the operations of the processes can be performed in a different order and still achieve desirable results.

1. A method comprising:
pseudorandomly selecting a first port from a plurality of ports that accept requests to access a shared resource; and
granting access to the shared resource for current requests from the plurality of ports, with granting of access in a deterministic order starting from a currently requesting port that is deterministically related to the first port.

2. The method of claim 1, further comprising, after all current requests have been granted at least once:
pseudorandomly selecting a second port from the plurality of ports that accept requests to access the shared resource; and
and granting access to the shared resource for current requests from the plurality of ports, with granting of access in a deterministic order starting from a currently requesting port that is deterministically related to the second port.

3. The method of claim 1 wherein the deterministic order is determined according to a round-robin arbitration scheme.

4. The method of claim 1 wherein the deterministic order is determined according to a batch arbitration scheme.

5. The method of claim 1 wherein pseudorandomly selecting comprises selecting the first port from a subset of the plurality of ports that accept requests to access the shared resource.

6. The method of claim 5 wherein the subset includes ports having a logical address that is within a predetermined range of a logical address of a previously selected port.

7. An apparatus comprising:
a shared resource;
a plurality of ports configured to accept requests to access the shared resource; and
an arbitration module configured to pseudorandomly select a first port from a plurality of ports; and
grant access to the shared resource for current requests from the plurality of ports, with granting of access in a deterministic order starting from a currently requesting port that is deterministically related to the first port.

8. The apparatus of claim 7, wherein the arbitration module is further configured to, after all current requests have been granted at least once:
pseudorandomly select a second port from the plurality of ports that accept requests to access the shared resource; and
and grant access to the shared resource for current requests from the plurality of ports, with granting of access in a deterministic order starting from a currently requesting port that is deterministically related to the second port.

9. The apparatus of claim 7 wherein the deterministic order is determined according to a round-robin arbitration scheme.

10. The apparatus of claim 7 wherein the deterministic order is determined according to a batch arbitration scheme.

11. A processor comprising:
circuitry configured to
pseudorandomly select a first port from a plurality of ports that accept requests to access a shared resource; and
grant access to the shared resource for current requests from the plurality of ports, with granting of access in a deterministic order starting from a currently requesting port that is deterministically related to the first port.

12. The processor of claim 11, wherein the circuitry is further configured to, after all current requests have been granted at least once:
pseudorandomly select a second port from the plurality of ports that accept requests to access the shared resource; and
and grant access to the shared resource for current requests from the plurality of ports, with granting of access in a deterministic order starting from a currently requesting port that is deterministically related to the second port.

13. The processor of claim 11 wherein the deterministic order is determined according to a round-robin arbitration scheme.

14. The processor of claim 11 wherein the deterministic order is determined according to a batch arbitration scheme.

15. A computer program product tangibly embodied on a computer readable medium, for managing a shared resource, comprising instructions for causing a computer to:
pseudorandomly select a first port from a plurality of ports that accept requests to access a shared resource; and
grant access to the shared resource for current requests from the plurality of ports, with granting of access in a deterministic order starting from a currently requesting port that is deterministically related to the first port.

16. The computer program product of claim 15, further comprising instructions for causing a computer to, after all current requests have been granted at least once:
pseudorandomly select a second port from the plurality of ports that accept requests to access the shared resource; and
and grant access to the shared resource for current requests from the plurality of ports, with granting of access in a deterministic order starting from a currently requesting port that is deterministically related to the second port.

17. The computer program product of claim 15 wherein the deterministic order is determined according to a round-robin arbitration scheme.

18. The computer program product of claim 15 wherein the deterministic order is determined according to a batch arbitration scheme.

19. A system comprising:
a network device including a plurality of input ports for receiving data packets;
a arbiter in communication with the input ports; and
a wireless physical layer device in communication with the network device;
wherein the arbiter is configured to pseudorandomly select a first port from a plurality of ports that accept requests to access a shared resource; and
grant access to the shared resource for current requests from the plurality of ports, with granting of access in a deterministic order starting from a currently requesting port that is deterministically related to the first port.

20. The system of claim 19, wherein the arbiter is further configured to, after all current requests have been granted at least once:
pseudorandomly select a second port from the plurality of ports that accept requests to access the shared resource; and
and grant access to the shared resource for current requests from the plurality of ports, with granting of access in a deterministic order starting from a currently requesting port that is deterministically related to the second port.

21. The system of claim 19 wherein the deterministic order is determined according to a round-robin arbitration scheme.

22. The system of claim 19 wherein the deterministic order is determined according to a batch arbitration scheme.
